(19) United States
(12) Patent Application Publication
(10) Pub. No.: US 2008/0028243 A1
(43) Pub. Date: Jan. 31, 2008

(54) INFORMATION PROCESSING APPARATUS AND A CONTROLLING METHOD FOR AN INFORMATION PROCESSING APPARATUS

(75) Inventor: Toshikazu Morisawa, Tokorozawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/777,163

(22) Filed: Jul. 12, 2007

(30) Foreign Application Priority Data
Jul. 26, 2006 (JP) 2006-203691

(51) Int. Cl. G06F 1/32

(52) U.S. Cl. 713/323

(57) ABSTRACT

According to one embodiment, an information processing apparatus including a CPU, a volatile memory device, a nonvolatile memory device, a first control unit which changes a system to a suspended state whereby the operation of the CPU is stopped while continuing power supply to the volatile memory device which stores a context indicating an execution state of the CPU, and saves the context in the nonvolatile memory device during the change to the suspended state, and a second control unit which changes the system to a hibernation state whereby the context is stored in the nonvolatile memory device and the operation of the CPU is stopped, by cutting off the power supply to the volatile memory device, when a predetermined situation has been detected in the suspended state of the system.

### CROSS-REFERENCE TO RELATED APPLICATIONS

This application is based upon and claims the benefit of priority from Japanese Patent Application No. 2006-203691, filed Jul. 26, 2006, the entire contents of which are incorporated herein by reference.

### BACKGROUND

1. Field

One embodiment of the invention relates to a control technology which can properly be applied to an information processing apparatus drivable by a battery such as a notebook computer (notebook PC).

2. Description of the Related Art

Recently, performance of notebook PCs which can each be powered by a battery and easily carried has rapidly been improved, for example, by providing a television broadcast reception function. In each of the computers of this type, a use frequency of a suspend/resume function is high, for example, to effectively use pieces of time during outing, more specifically, to smoothly suspend or resume work.

In the case of the computer of this type, it is very important to securely prolong a battery driving time, i.e., a continuous operation time during carrying. Therefore, various mechanisms for power saving without impairing usability have been proposed (e.g., Jpn. Pat. Appln. KOKAI Publication No. 9-237128).

A computer system described in Jpn. Pat. Appln. KOKAI Publication No. 9-237128 mentioned above includes a mechanism that after the system has been set to a suspended state, the system automatically changes from the suspended state to a hibernation state with the passage of time. The suspended state means that a system state is maintained by continuing power supply to a main memory when an operation of the computer is stopped. The hibernation state means that the system state is maintained by writing contents of the main memory to a nonvolatile memory device such as an HDD.

In the hibernation state, the contents of the main memory are written to the nonvolatile memory device, and hence the power supply to the main memory is unnecessary. Accordingly, if there is provided the mechanism that the system automatically changes to the hibernation state, proper control is realized when a predetermined time passes after the setting of the suspended state.

For example, when the user leaves a seat and suspends the operation of the computer to prevent watching of a display screen, the suspended state is maintained. Then, when the user comes back to the seat, the operation is quickly resumed. On the other hand, when the user intends to leave the seat only for a little time but actually leaves the seat for an unexpectedly long time, the system automatically changes to the hibernation state to save the power.

According to the computer described in Jpn. Pat. Appln. KOKAI Publication No. 9-237128 mentioned above, the system changes to the hibernation state when the suspended state continues over a predetermined time. In other words, even in a situation that the system is to change to the hibernation state before the passage of a predetermined time, the system keeps a standby state until the predetermined time passes.

If there becomes the situation that the system is to change to the hibernation state, it is preferable from the standpoint of the power saving that the system properly changes to the hibernation state, even immediately after the change to the suspended state.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a system configuration of an information processing apparatus according to a first embodiment of the present invention;

FIG. 2 is an exemplary flowchart showing a state change of the information processing apparatus of the first embodiment;

FIG. 3 is an exemplary flowchart showing an operation process of power supply control executed by an EC/KBC of the information processing apparatus of the first embodiment;

FIG. 4 is an exemplary diagram showing a system configuration of an information processing apparatus according to a second embodiment of the present invention;

FIG. 5 is an exemplary flowchart showing a state change of the information processing apparatus of the second embodiment;

FIG. 6 is an exemplary flowchart showing an operation process of power supply control executed by an EC/KBC of the information processing apparatus of the second embodiment;

FIG. 7 is an exemplary appearance diagram of an information processing apparatus (realized as a notebook PC) according to a third embodiment of the present invention;

FIG. 8 is an exemplary appearance diagrams of the information processing apparatus (realized as a compatible tablet PC) of the third embodiment;

FIG. 9 is an exemplary diagram showing a system configuration of the information processing apparatus of the third embodiment;

FIG. 10 is an exemplary flowchart showing a state change of the information processing apparatus of the third embodiment;

FIG. 11 is an exemplary flowchart showing an operation process of power supply control executed by an EC/KBC of the information processing apparatus of the third embodiment;

FIG. 12 is an exemplary diagram showing a system configuration of an information processing apparatus according to a fourth embodiment of the present invention;

FIG. 13 is an exemplary diagram showing a setting screen displayed by a power management utility program operated in the information processing apparatus of the fourth embodiment;

FIG. 14 is an exemplary flowchart showing a state change of the information processing apparatus of the fourth embodiment;

FIG. 15 is an exemplary flowchart showing an operation process of power supply control executed by an EC/KBC of the information processing apparatus of the fourth embodiment; and

FIG. 16 is a diagram showing a modified example of the setting screen displayed by the power management utility program operated in the information processing apparatus of the fourth embodiment.

### DETAILED DESCRIPTION

Various embodiments according to the invention will be described hereinafter with reference to the accompanying drawings. In general, according to one embodiment of the invention, an information processing apparatus includes a CPU, a volatile memory device to which a memory space configured to be accessed by the CPU is allocated, a nonvolatile memory device, a first control unit configured to change a system to a suspended state whereby the operation of the CPU is stopped while continuing power supply to the volatile memory device which stores a context indicating an execution state, containing data of the memory space, of the CPU, and to save the context in the nonvolatile memory device during the change to the suspended state, and a second control unit configured to change the system to a hibernation state whereby the context is stored in the nonvolatile memory device and the operation of the CPU is stopped, by cutting off the power supply to the volatile memory device, when a predetermined situation has been detected in the suspended state of the system.

### First Embodiment

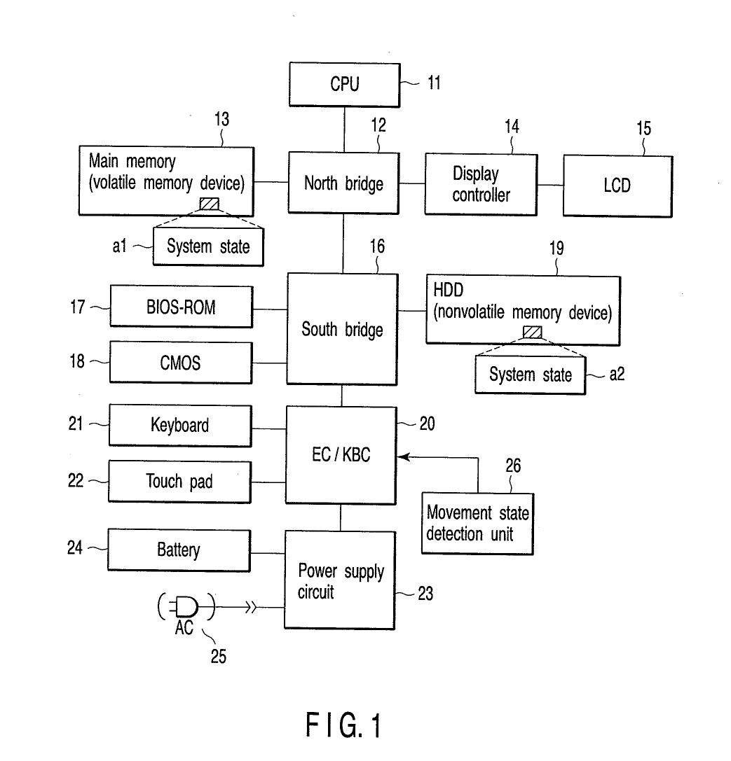

First, a first embodiment of the present invention will be described. FIG. 1 is an exemplary diagram showing a system configuration of an information processing apparatus according to the first embodiment. For example, this information processing apparatus is realized as a notebook PC.

As shown in FIG. 1, the computer (PC) includes a CPU 11, a north bridge 12, a main memory (volatile memory device) 13, a display controller 14, a liquid crystal display (LCD) 15, a south bridge 16, a basic input/output system (BIOS)-ROM 17, a complementary metal-oxide semiconductor (CMOS) 18, an HDD (nonvolatile memory device) 19, an embedded controller/keyboard controller (EC/KBC) 20, a keyboard 21, a touch pad 22, a power supply circuit 23, a battery 24, and a movement state detection unit 26.

The CPU 11 is a processor for controlling an operation of the computer, and executes various programs such as an operating system, a utility, and applications loaded from the HDD 19 to the main memory 13. A memory area that the CPU 11 can directly access, i.e., a memory space, is allocated to the main memory 13 which is a volatile memory device. The computer has a suspend function of holding a state of a system (system state a1) during an operation stop (supply of power to sections other then the main memory 13 is discontinued) by holding a context (system state) containing data of the memory space in the main memory and continuing supply of power to the main memory 13. This suspend function is realized under control of the operating system. More specifically, the operating system (CPU 11 which executes the operating system) issues an instruction of a change to the EC/KBC 20 to execute the suspend function.

The operating system executes and controls preparation processing for enabling a quick change to a hibernation state, i.e., the context held in the main memory 13 is saved in the HDD 19 which is a nonvolatile memory device (system state a2), during the change to the suspended state. In the suspended state, the computer monitors whether there becomes a situation that the computer is to change to a hibernation state, and properly changes to the hibernation state (even immediately after the change to the suspended state) when the situation that the system is to change to the hibernation state is detected. This point will be described below in detail. The CPU 11 executes a BIOS stored in the BIOS-ROM 17. The BIOS is a program for controlling hardware.

The north bridge 12 is a bridge device for interconnecting a local bus of the CPU 11 and the south bridge 16. The north bridge 12 incorporates a memory controller for controlling access to the main memory 13. The north bridge 12 has a function of communicating with the display controller 14. The display controller 14 controls displaying of the LCD 15.

The south bridge 16 controls a device connected to a system bus such as a low pin count (LPC) bus or a peripheral component interconnect (PCI) bus. Various memory devices including the BIOS-ROM 17, the CMOS 18 and the HDD 19 are connected to the south bridge 16. The south bridge 16 incorporates a memory controller for controlling access to the BIOS-ROM 17 and the CMOS 18, and an integrated drive electronics (IDE) controller for controlling access to the HDD 19.

The EC/KBC 20 is a single-chip microcomputer which has a function of controlling the keyboard 21 and the touch pad 22, and a power management function for supplying power from the battery 24 or an external power source 25 in cooperation with the power supply circuit 23. The power from the battery 24 or the external power source 25 is always supplied to the EC/KBC 20 under control of the power supply circuit 23. In other words, even in the suspended state, power supply to the EC/KBC 20 is continued (in addition to power supply to the main memory 13). In the suspended state, the EC/KBC 20 monitors a detection signal from the movement state detection unit 26.

For example, the movement state detection unit 26 includes a three-axis acceleration sensor, and when the computer is carried around, the movement state detection unit 26 detects its movement to output a control signal. When the EC/KBC 20 that monitors the detection signal from the movement state detection unit 26 recognizes the movement caused by the computer being carried, the EC/KBC 20 instructs cutting-off of power supply to the main memory 13 to the power supply circuit 213. In other words, at a point of this time, the computer changes from the suspended state to the hibernation state.

In the case that the computer is in the movement state, the computer is often put in a bag or the like and is not used for some time. Therefore, the change to the hibernation state can realize power saving.

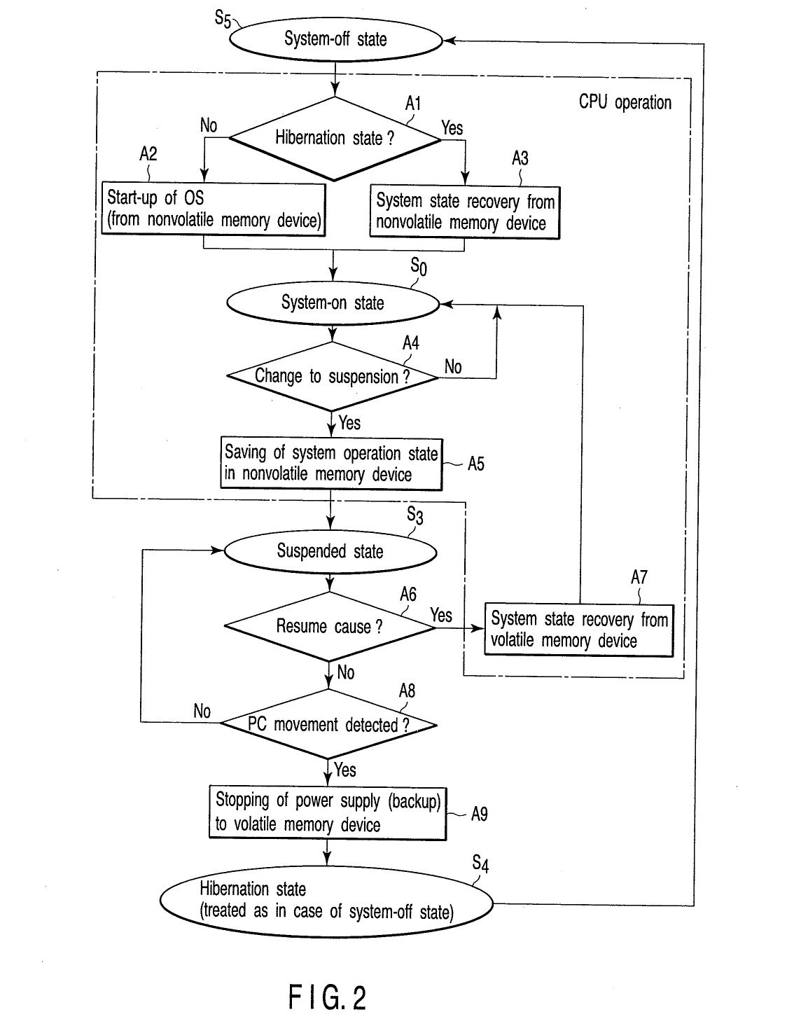

FIG. 2 is an exemplary flowchart showing a stage change of the computer. The computer can take four states including a system-on state (S₀), a suspended state (S₃), a hibernation state (S₄), and a system-off state (S₅). While there is a difference internally, the hibernation state and the system-off state are objectively treated in the same manner. The computer changes between these four states as follows.

In the system-off state, when a system-on cause is generated by operation of a power switch, operation of the CPU 11 is started to determine whether the system is in a hibernation state (block A1). If the system is not in the hibernation state (No in block A1), the CPU 11 starts up the operating system from the HDD 19 (block A2) to change the system to the system-on state. On the other hand, if the system is in the hibernation state (Yes in block A1), the CPU 11 restores the system state a2 saved in the HDD 19 in the main memory 13 (block A3) to change the system to the system-on state.

In the system-on state, when a suspension change cause is generated (block A4), the CPU 11 saves contents of the main memory 13 in the HDD 19 (block A5), and then instructs a change to a suspended state to the EC/KBC 20 (cutting-off of power supply to sections other than the main memory 13) to change the system to the suspended state. As a result, power supply to the CPU 11 is cut off to stop the operation of the computer. Even in this operation stopped state, power supply to the EC/KBC 20 is continued.

In the suspended state, when a resume cause such as an operation of the power switch is generated (Yes in block A6), the EC/KBC 20 controls the power supply circuit 23 to resume the power supply to the sections including the CPU 11 which has been cut off (block A7), thereby restoring the system-on state of the system. On the other hand, when movement of the computer is detected based on the detection signal from the movement state detection unit 26 (Yes in block A8) without any resume cause being generated (No in block A6), the EC/KBC 20 controls the power supply circuit 23 to stop the power supply to the main memory 13 which has been continued (block A9), thereby changing the system to a hibernation state.

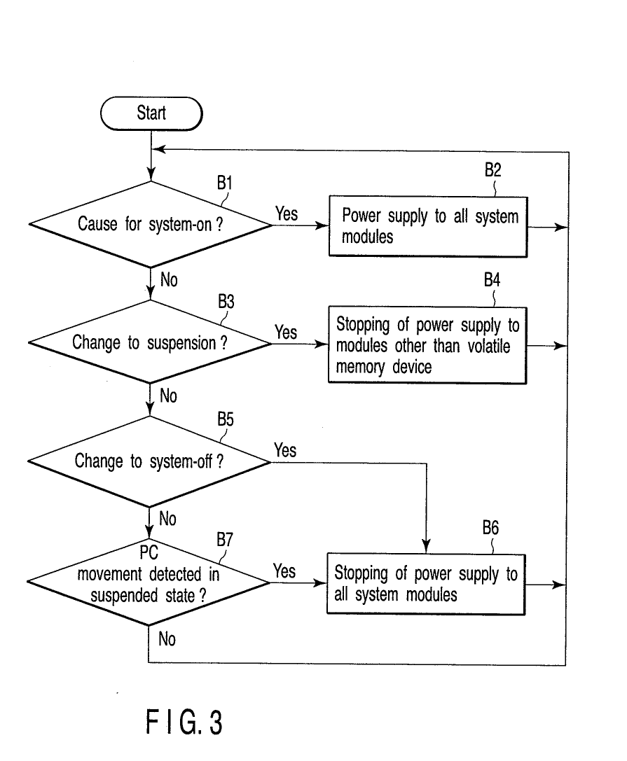

FIG. 3 is an exemplary flowchart showing an operation process of power supply control executed by the EC/KBC 20 regarding the state change of the computer shown in FIG. 2.

When the EC/KBC 20 recognizes a system-on cause such as operation of the power switch (Yes in block B1), the EC/KBC 20 instructs the power supply circuit 23 to supply power to all system modules (block B2). Furthermore, when the EC/KBC 20 receives an instruction of a change to a suspended state from the operating system (No in block B1, Yes in B3), the EC/KBC 20 instructs the power supply circuit 23 to stop power supply to the sections other than the main memory 13 as the volatile memory device for holding the system state 1a (block B4). At this time, the system state a2 is saved in the HDD 19 as the nonvolatile memory device under control of the CPU 11.

When a system-off cause is recognized (No in block B3, Yes in B5), the EC/KBC 20 instructs the power supply circuit 23 to stop the power supply to all the modules including the main memory 13 (block B6). Furthermore, also when the EC/KBC 20 detects movement of the PC based on the detection signal from the movement state detection unit 26 in the suspended state (No in block B5, Yes in B7), the EC/KBC 20 instructs the power supply circuit 23 to stop the power supply to all the modules including the main memory 13 (block B6).

Thus, the computer monitors whether it is to change to the hibernation state in the case that the computer is in the suspended state. When the computer detects the situation that the computer is to change to the hibernation state (even immediately after the change to the suspended state), the computer properly changes to the hibernation state.

### Second Embodiment

Next, a second embodiment will be described.

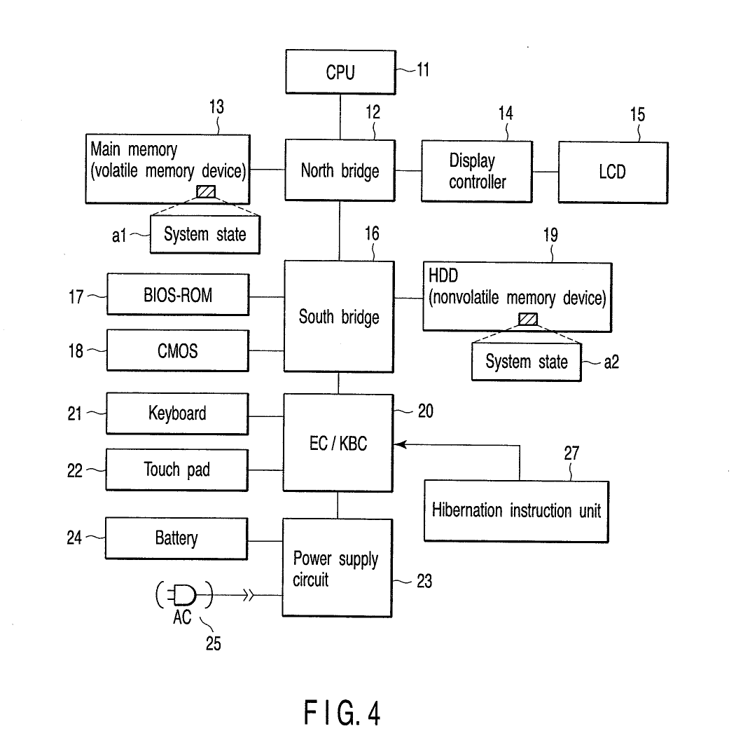

FIG. 4 shows an exemplary system configuration of an information processing apparatus according to the second embodiment.

As shown in FIG. 4, the information processing apparatus (computer) of the second embodiment is different from the computer of the first embodiment in that a hibernation instruction unit 27 is provided in place of the movement state detection unit 26.

The hibernation instruction unit 27 is provided to enable a change of the computer of a suspended state to a hibernation state by user's intension. For example, the hibernation instruction unit 27 may include a dedicated switch, or a power switch to be pressed over a predetermined time (an original operation of the power switch is executed in the case of pressing within the predetermined time).

For example, presuming that the computer includes a dedicated switch, when the switch is operated, the hibernation instruction unit 27 outputs a signal indicating the switch operation. In a suspended state, an EC/KBC 20 of the embodiment monitors presence of a signal output from the hibernation instruction unit 27. The outputting of the signal from the hibernation instruction unit 27 means that a user wishes a change to a hibernation state. Accordingly, the EC/KBC 20 immediately executes the change.

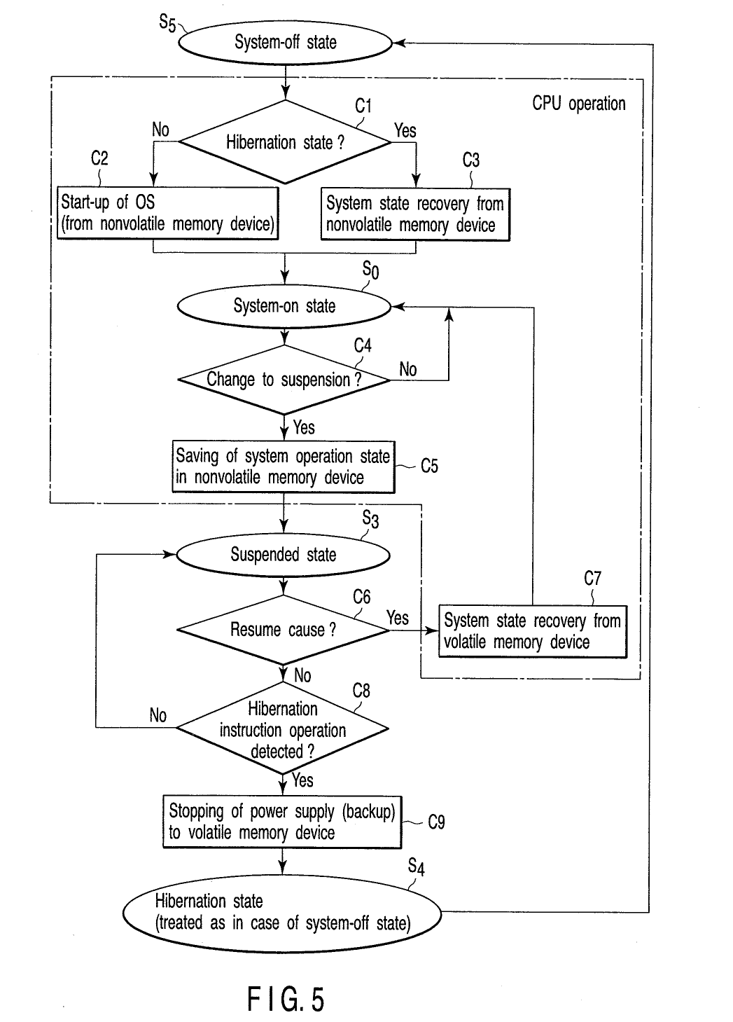

FIG. 5 is an exemplary flowchart showing a state change of the computer. Only a difference from the computer of the first embodiment will be described. In the suspended state, when a signal output from the hibernation instruction unit 27 is detected (Yes in block C8) without any resume cause generated (No in block C6), the EC/KBC 20 controls a power supply circuit 23 to stop power supply to a main memory 13 which has been continued (block C9), thereby changing the system to a hibernation state.

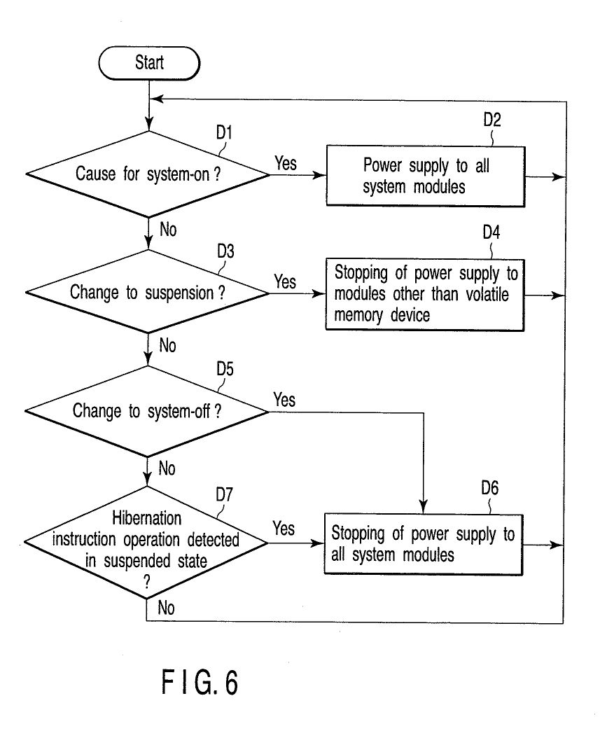

FIG. 6 is an exemplary flowchart showing an operation process of power supply control executed by the EC/KBC 20 of the embodiment. Only a difference from the computer of the first embodiment will be described. When the EC/KBC 20 detects a signal output from the hibernation instruction unit 27 in the suspended state (No in block D5, Yes in D7), the EC/KBC 20 instructs the power supply circuit 23 to stop power supply to all modules including the main memory 13 (block D6).

Thus, according to the second embodiment, the computer monitors whether there becomes a situation that the computer is to change to the hibernation state in the case that the computer is in the suspended state. When the situation that the computer is to change to the hibernation state is detected, the computer properly changes to the hibernation state (even immediately after the change to the suspended state).

### Third Embodiment

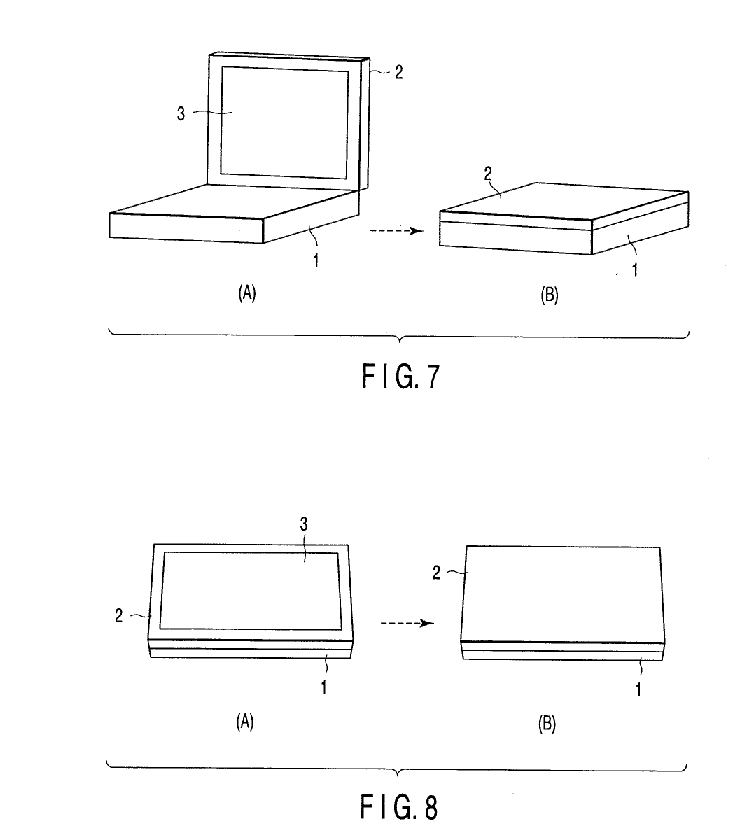

Next, a third embodiment of the present invention will be described. Each of FIGS. 7 and 8 shows an exemplary appearance of an information processing apparatus according to the third embodiment.

FIG. 7 shows a case in which the information processing apparatus of the embodiment is realized as a notebook PC, (A) of FIG. 7 showing an opened state of a panel 2 which includes a display surface 3 of an LCD 15, and (B) of FIG. 7 showing a closed state of the panel 2. FIG. 8 shows a case in which the information processing apparatus of the embodiment is realized as a compatible tablet PC, (A) of FIG. 8 showing a closed state of a panel 2 in which a surface including a display surface 3 of an LCD 15 having a tablet superposed thereon is outward, and (B) of FIG. 8 showing a closed state of the panel 2 in which this surface is inward.

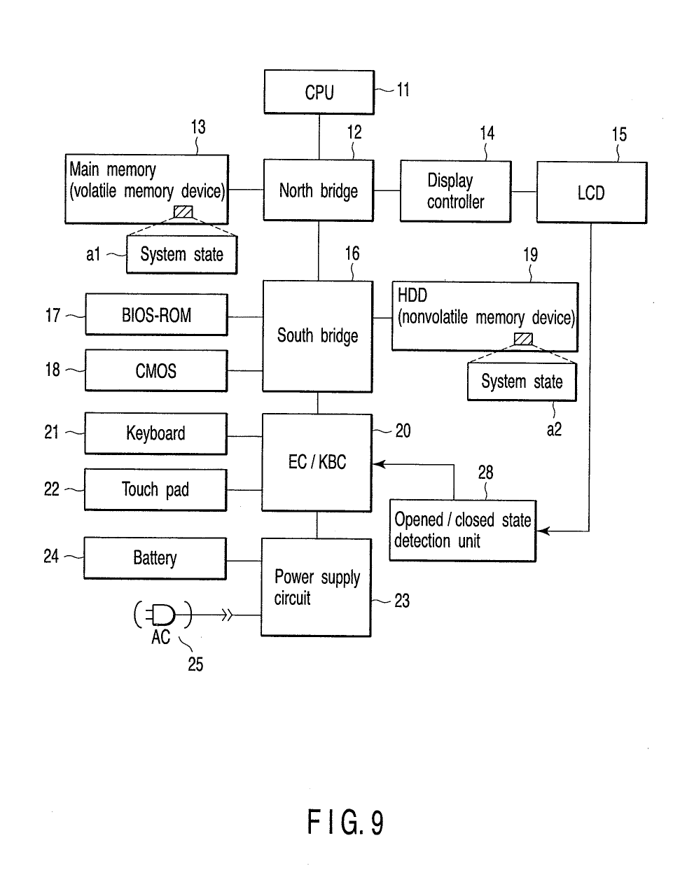

In both cases of the notebook PC and the compatible tablet PC, in a state of (B) during the suspended state, i.e., when the LCD display surface is closed because of nonuse for a long time, the computer immediately changes to a hibernation state. FIG. 9 shows a system configuration of the information processing apparatus of the third embodiment.

To detect the states of (B), the computer includes an opened/closed state detection unit 28 in place of the movement state detection unit 26 of the first embodiment and the hibernation instruction unit 27 of the second embodiment. The opened/closed state detection unit 28 detects a binary opened or closed state in the case of the notebook PC, and an inward closed state of the panel from (opened/closed state and rotated state) in the case of the compatible table PC to output control signals. The EC/KBC 20 of the embodiment monitors presence of a signal output from the opened/closed state detection unit 28 in the suspended state, and immediately executes a change to a hibernation state when a signal is output.

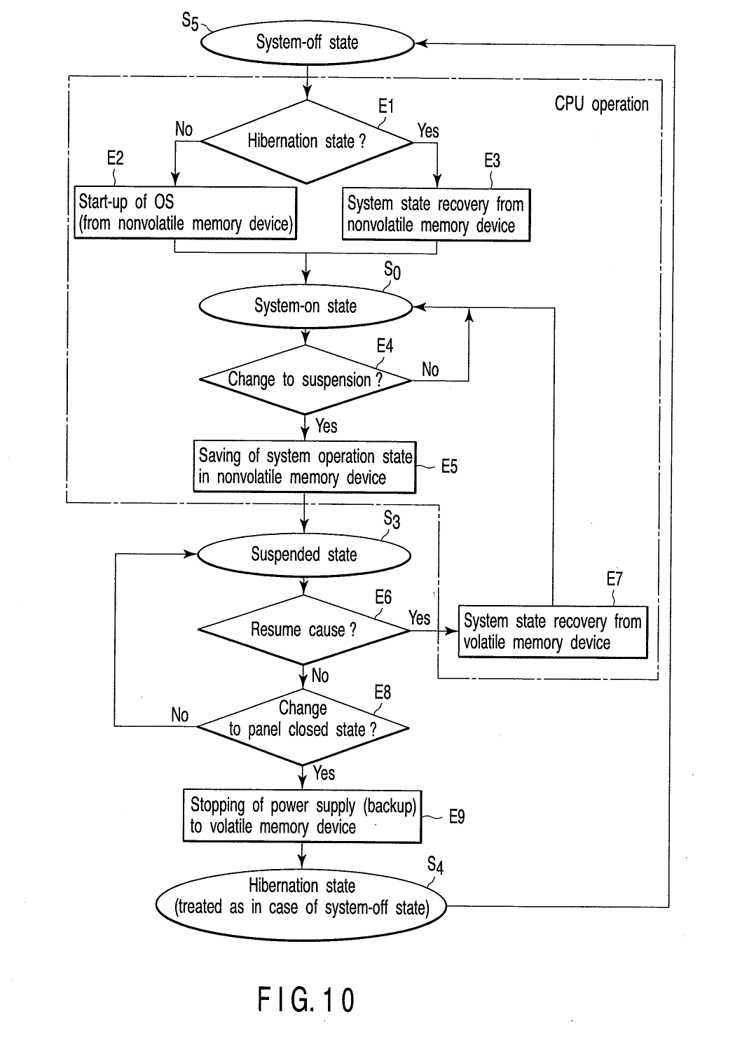

FIG. 10 is an exemplary flowchart showing a status change of the computer. Only a difference from the computer of the first embodiment will be described. In the suspended state, when a change to a panel closed state is detected based on a detection signal from the opened/closed state detection unit 28 (Yes in block E8) without generating any resume cause (No in block E6), the EC/KBC 20 controls the power supply circuit 23 to stop power supply to the main memory 13 which has been continued (block E9) to change the system to a hibernation state.

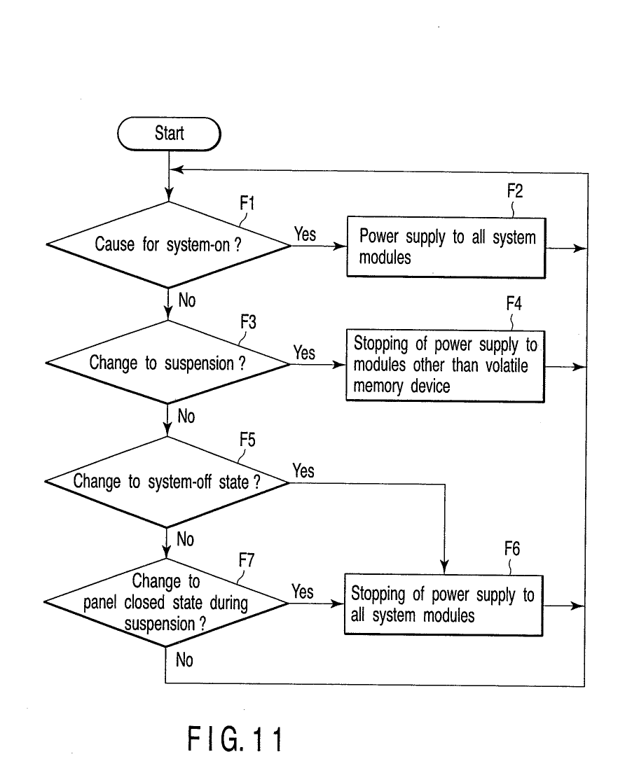

FIG. 11 is an exemplary flowchart showing an operation process of power supply control executed by the EC/KBC 20 of the computer. Only a difference from the computer of the first embodiment will be described. When the EC/KBC 20 detects a change to an opened/closed state based on the detection signal from the opened/closed state detection unit 28 in the suspended state (No in block F5, Yes in block F7), the EC/KBC 20 instructs the power supply circuit 23 to stop power supply to all modules including the main memory 13 (block F6).

Thus, according to the third embodiment, the computer monitors whether there becomes a situation that the computer is to change to the hibernation state in the case that the computer is in the suspended state. When the situation that the computer is to change to the hibernation state is detected, the computer properly changes to the hibernation state (even immediately after the change to the suspended state).

### Fourth Embodiment

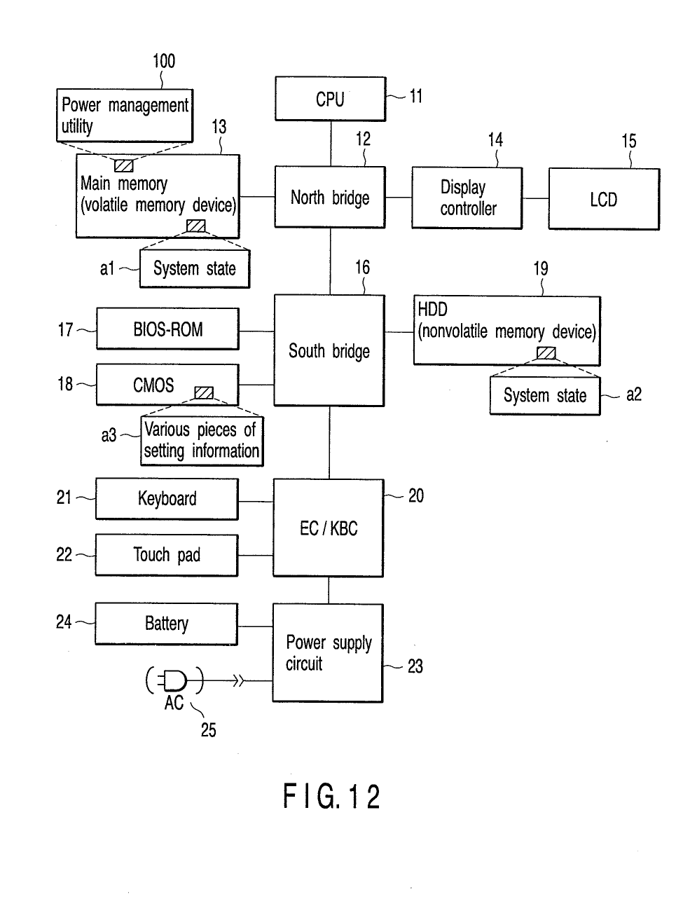

Next, a fourth embodiment of the present invention will be described. FIG. 12 is an exemplary diagram showing a system configuration of an information processing apparatus according to the fourth embodiment.

Considering a request that a residual amount of a battery 24 is secured during resumption, the information processing apparatus (computer) of the fourth embodiment monitors a residual amount of the battery 24 (consumed to supply power to a main memory 13) after a change to a suspended state. Then, at timing when the residual amount of the battery is equal or less than a predetermined value, a change to a hibernation state is executed.

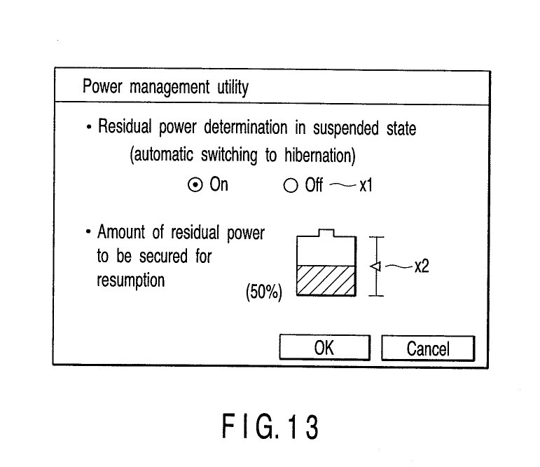

The computer provides a power management utility program 100 for setting a residual amount of the battery 24 to be secured during the resumption. For example, when started, the power management utility program 100 displays a setting screen similar to that shown in FIG. 13.

On the setting screen, a select button x1 is arranged to set whether to check a residual amount of the battery 24 to change to a hibernation state when necessary, in the case of a suspended state. The select button x1 is a radio button which can exclusively execute one of switching on and off. On the setting screen, a scale x2 is also arranged for determining a reference value of the residual amount. A desired value can be determined by sliding (dragging) the needle on the divisions of the scale x2. The power management utility program 100 stores contents set on the setting screen in a CMOS 18 which is a nonvolatile memory device (various pieces of setting information a3).

An EC/KBC 20 of the embodiment refers to information stored in the CMOS 18 when changing to a suspended state, and monitors a residual amount of a battery 24 via a power supply circuit 23 if setting has been set to check the residual amount of the battery 24. When the residual amount of the battery 24 is equal or less than a set value, a change to a hibernation state is executed. This processing is not carried out when power from an external power source 25 can be input. When the residual amount of the battery is equal to or less than the set value at the time of changing to the suspended state, the EC/KBC 20 immediately executes a change to a hibernation state.

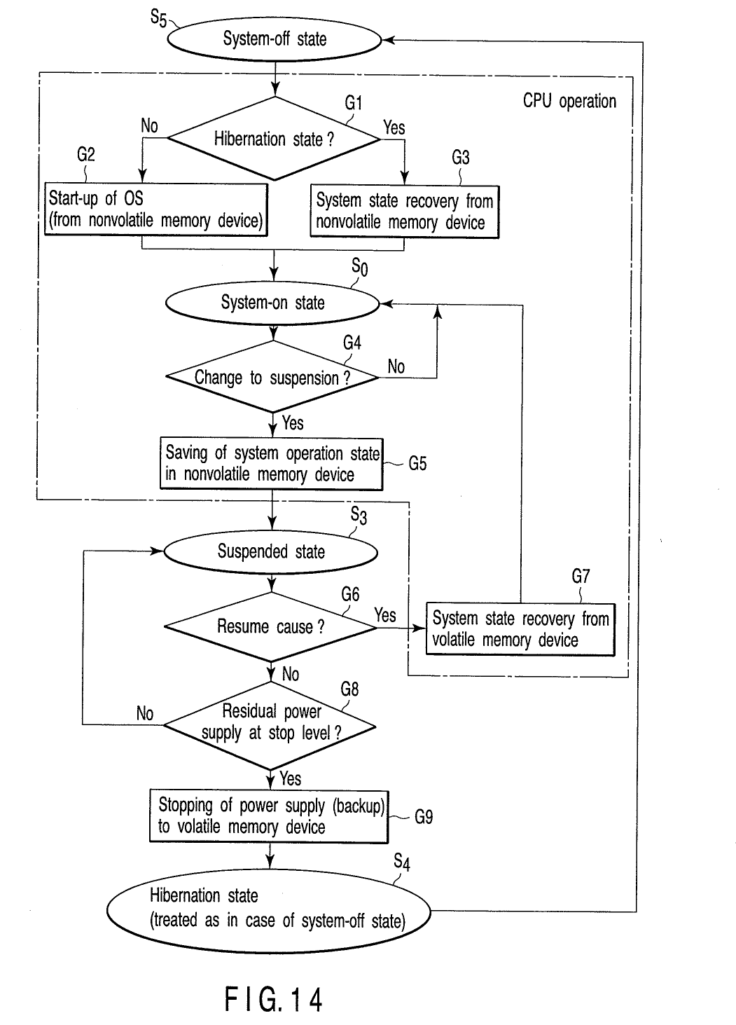

FIG. 14 is an exemplary flowchart showing a state change of the computer. Only a difference from the computer of the first embodiment will be described. In a suspended state, when it is detected that a residual amount of the battery 24 is equal to or less than a set value (Yes in block G8) without generating any resume cause (No in block G6), the EC/KBC 20 controls a power supply circuit 23 to stop power supply to a main memory 13 which has been continued (block G9) to change the system to a hibernation state.

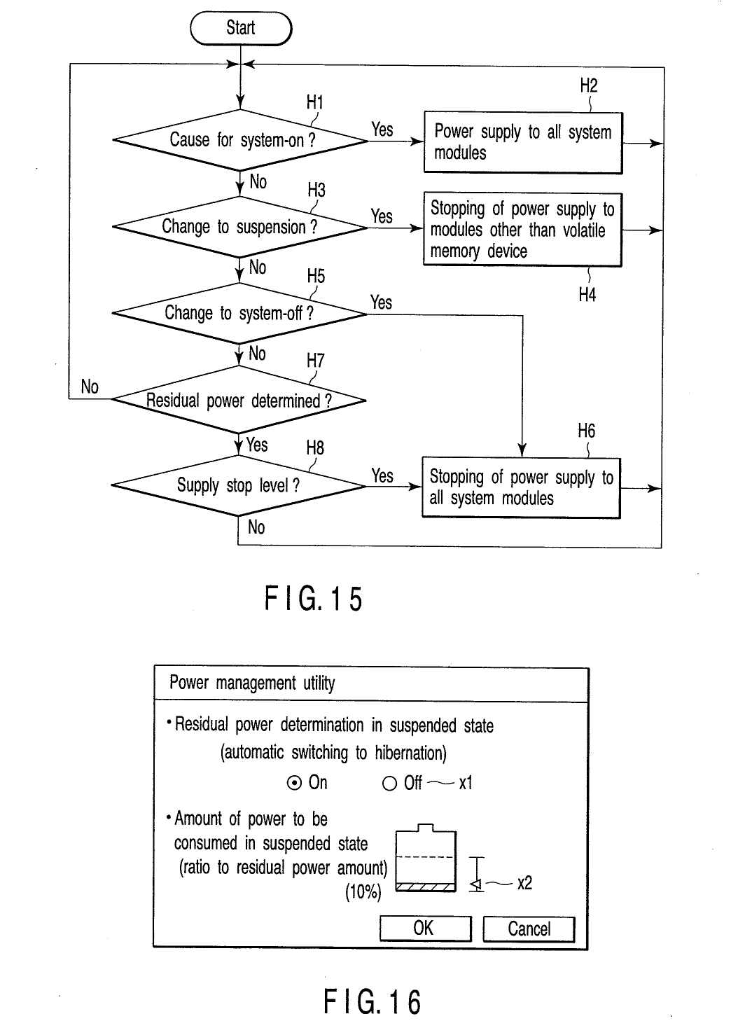

FIG. 15 is an exemplary flowchart showing an operation process of power supply control executed by the EC/KBC 20 of the computer. Only a difference from the computer of the first embodiment will be described. In the suspended state, when it is detected that a situation has been set to check a residual amount of the battery 24 (No in block H5, Yes in H7) and the residual amount of the battery 24 is equal to or less than the set value (Yes in block H8), the EC/KBC 20 instructs the power supply circuit 23 to stop power supply to all modules including the main memory 13 (block H6).

As a reference value for changing the system from the suspended state to the hibernation state, the example of setting the residual amount of the battery 24 to be secured during the resumption has been described. However, a power amount of the battery 24 to be consumed for maintaining the suspended state may be set. When setting shown in FIG. 16 is carried out, the EC/KBC 20 executes a change to the hibernation state at the time of consuming 10% of the residual amount of the battery 24 during the change to the suspended state. Other various values can be used as reference values.

The control methods of the embodiments do not need to be individually applied as described above. Needless to say, however, a plurality or all of “move” and “switch operation”, “move” and “panel open”, “switch” and “battery residual amount”, and the like may be combined to be applied.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a CPU;
a volatile memory device to which a memory space configured to be accessed by the CPU is allocated;
a nonvolatile memory device;
a first control unit configured to change a system to a suspended state that stops the operation of the CPU while continuing power supply to the volatile memory device that stores a context indicating an execution state of the CPU in the memory space;
the first control unit further configured to save the context in the nonvolatile memory device during a change to the suspended state; and
a second control unit configured to change the system to a hibernation state that stops the operation of the CPU by cutting off the power supply to the volatile memory device when a predetermined situation had been detected in the suspended state of the system.

2. The information processing apparatus according to claim 1, further comprising a movement detection unit configured to detect movement of a main body of the apparatus,
wherein the second control unit is configured to change the system to the hibernation state when the movement detection unit detect the movement of the main body.

3. The information processing apparatus according to claim 2,
wherein the movement detection unit comprises a three-axis acceleration sensor.

4. The information processing apparatus according to claim 1, further comprising an operation unit configured to input an instruction of changing the system of the suspended state to the hibernation state,
wherein the second control unit is configured to change the system to the hibernation state when the operation unit inputs the instruction.

5. The information processing apparatus according to claim 4,
wherein the second control unit is configured to recognize a power switch operation as an input operation of the instruction when the power switch for turning on or off a power source of the system is operated over a predetermined time.

6. The information processing apparatus according to claim 1, further comprising:
a cap; and
an opening/closing detection unit configured to detect an opened/closed state of the cap,
wherein the second control unit is configured to change the system to the hibernation state when the opening/closing detection unit detects a closed state of the cap.

7. The information processing apparatus according to claim 6, wherein one surface of the cap comprises a display device on which a tablet is superposed, and
the second control unit is configured to change the system to the hibernation state when the opening/closing detection unit detects a state in which the cap is closed, with the surface having the display device being inward.

8. The information processing apparatus according to claim 1, further comprising:
a battery; and
a residual amount detection unit configured to detect a residual amount of the battery,
wherein the second control unit is configured to change the system to the hibernation state, when the residual amount of the battery detection by the residual amount detection unit is equal to or less than a predetermined value while the power supply to the volatile memory device is continued with power supplied from the battery.

9. The information processing apparatus according to claim 8, further comprising a setting unit configured to set the predetermined value.

10. The information processing apparatus according to claim 8, further comprising a setting unit configured to set a power amount of the battery to be supplied to the volatile memory device for maintaining the suspended state in accordance with a ratio to a residual amount of the battery at the time of changing to the suspended state,
wherein the second control unit is configured to change the system to the hibernation state, when a power amount of the battery consumed for maintaining the suspended state from the time of changing to the suspended state is calculated from the residual amount of the battery detected by the residual amount detection unit and the calculated power amount reaches the power amount set by the setting unit.

11. A controlling method of an information processing apparatus, comprising:
changing the information processing apparatus to a suspended state that stops the operation of a CPU while continuing power supply to a volatile memory device that stores a context indicating an execution state-of the CPU;
saving the context in a nonvolatile memory device during the change to the suspended state; and
changing the system to a hibernation state that stops the operation of the CPU by cutting off the power supply to the volatile memory device when a predetermined situation has been detected in the suspended state of the system.
